(19) United States
(12) Patent Application Publication
(10) Pub. No.: US 2025/0181467 A1
(43) Pub. Date: Jun. 5, 2025

(54) EVALUATION DEVICE AND EVALUATION METHOD

(71) Applicant: Panasonic Automotive Systems Co., Ltd., Kanagawa (JP)

(72) Inventors: Shuya YAMAMOTO, Hyogo Ken (JP); Rintaro TOYOSHIMA, Kanagawa Ken (JP); Hideo FUJII, Kanagawa Ken (JP); Takuto SAIJO, Kanagawa Ken (JP)

(73) Assignee: Panasonic Automotive Systems Co., Ltd., Kanagawa (JP)

(21) Appl. No.: 18/958,798

(22) Filed: Nov. 25, 2024

(30) Foreign Application Priority Data
Nov. 30, 2023 (JP) 2023-202699

(51) Int. Cl. G06F 11/27; G06F 11/22; G09G 5/00

(52) U.S. Cl. CPC G06F 11/27; G06F 11/2221; G09G 5/003

(57) ABSTRACT

An evaluation device includes a storage device and a processor that is connected to the storage device. The storage device stores a test program in which one or more commands are described. The one or more commands include a first command that simulates a user operation on a device with multiple screens. The first command causes the device to perform an action responding to the user operation. The processor determines, from among the multiple screens, a relevant screen that is relevant to a command in an execution phase among all commands described in the test program. The processor executes functional testing of the device by sequentially executing all the commands. The processor captures a screen display on each of the multiple screens at a frame rate based on a result of the determination of the relevant screen.

### CROSS-REFERENCE TO RELATED APPLICATIONS

This application is based upon and claims the benefit of priority from Japanese Patent Application No. 2023-202699, filed on Nov. 30, 2023, the entire contents of which are incorporated herein by reference.

### FIELD

Embodiments described herein relate generally to an evaluation device and an evaluation method.

### BACKGROUND

Conventionally known automatic evaluation devices automatically perform functional testing based on test scenarios prepared in advance in order to evaluate screen displays and screen transitions performed in display devices.

For example, Japanese Patent Application Laid-open No. H10-340201 discloses a technique for testing display screens by comparing a screen display presented on a display device by a system under test with test data generated in advance.

However, when an object under test is a device with multiple screens, the processing load involved with capture of their screen displays and the data volume to be captured may increase with the number of the multiple screens.

As the number of screens to be tested increases, more resources are requested for processing and recording involved with the screen capture, or the action slows down due to high load on the resources.

Therefore, it is desirable to reduce the load involved with screen capture in automatic evaluation for screen displays on a device with multiple screens.

### SUMMARY

An evaluation device according to one aspect of the present disclosure includes a storage device and a hardware processor. The storage device is configured to store a test program in which one or more commands are described. The one or more commands include a first command that simulates a user operation on a device with multiple screens. The first command causes the device to perform an action responding to the user operation. The hardware processor is connected to the storage device. The hardware processor is configured to determine, from among the multiple screens, a relevant screen being relevant to a command in an execution phase among all commands described in the test program. The hardware processor is configured to execute functional testing of the device by sequentially executing all the commands. The hardware processor is configured to capture a screen display on each of the multiple screens at a frame rate based on a result of the determination of the relevant screen.

### BRIEF DESCRIPTION OF THE DRAWINGS

FIG. 1 is a diagram illustrating an exemplary configuration of an evaluation system according to one or more embodiments;

FIG. 2 is a diagram illustrating an exemplary hardware configuration of each device in the evaluation system according to one or more embodiments;

FIG. 3 is a diagram illustrating an exemplary test program according to one or more embodiments;

FIG. 4 is a diagram illustrating control of screen capture according to one or more embodiments;

FIG. 5 is a flowchart illustrating an exemplary procedure of an evaluation process executed in an automatic evaluation device according to one or more embodiments;

FIG. 6 is a flowchart illustrating another exemplary procedure of the evaluation process executed in the automatic evaluation device according to one or more embodiments; and

FIG. 7 is a flowchart illustrating yet another exemplary procedure of the evaluation process executed in the automatic evaluation device according to one or more embodiments.

### DETAILED DESCRIPTION

Embodiments of an evaluation system, an evaluation device, an evaluation method, a computer program, and a recording medium according to the present disclosure will be described below with reference to the drawings.

In the description of the present disclosure, components having identical or similar functions to those in the drawings previously mentioned may be denoted by like reference signs, and a description thereof may be omitted as appropriate. Identical or similar parts may be represented in different dimensions and proportions in the drawings. From the viewpoint of ensuring the visibility of the drawings, reference signs may be provided only for main components in a description of the drawings, and reference signs are not necessarily provided for components having identical or similar functions to those in the drawings previously mentioned.

In the description of the present disclosure, components having identical or similar functions may be distinguished from each other by appending alphanumeric characters to the end of reference signs. Alternatively, when two or more components having identical or similar functions are not distinguished from each other, the components may be collectively denoted without alphanumeric characters appended to the end of reference signs.

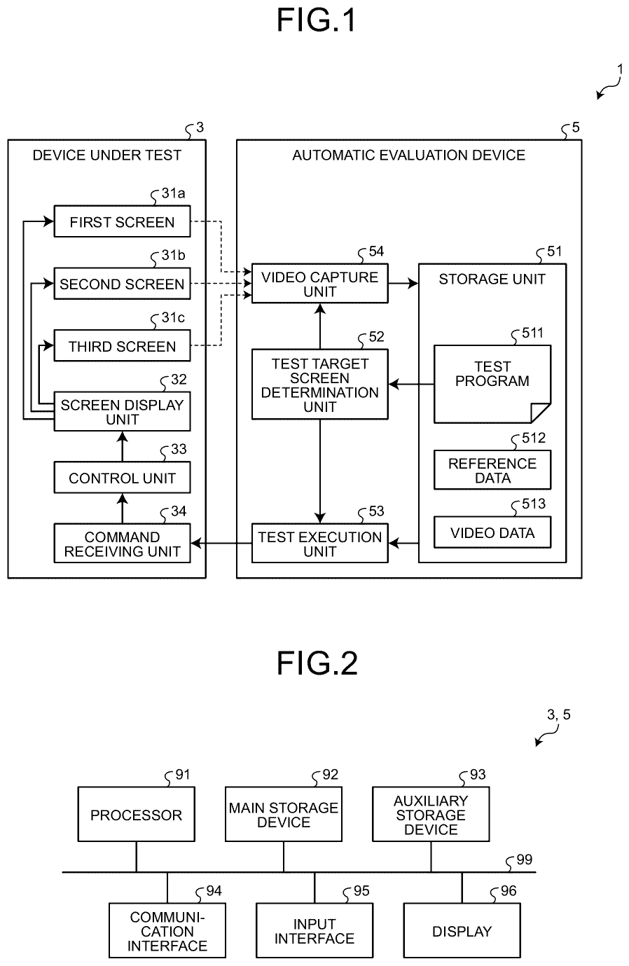

FIG. 1 is a diagram illustrating an exemplary configuration of an evaluation system 1 according to one or more embodiments. The evaluation system 1 according to one or more embodiments is an automatic evaluation system configured to automatically perform consolidated functional testing by simulating user operations on a device under test 3 having multiple screens. As illustrated in FIG. 1, the evaluation system 1 includes the device under test 3 and an automatic evaluation device 5.

In the evaluation system 1 according to one or more embodiments, the device under test 3 and the automatic evaluation device 5 are connected so as to communicate with each other via, for example, a dedicated cable. The connection between the device under test 3 and the automatic evaluation device 5 is not limited to wired connection, but may be wireless connection. This communication may be via telecommunication lines such as the Internet.

The device under test 3 according to one or more embodiments is an example of a device to be tested, namely, a device to be subjected to automatic evaluation of screen displays. The device under test 3 includes multiple screens (displays 96). When the device under test 3 is an in-vehicle device, the multiple screens may be, for example, screens of various display devices such as an in-vehicle infotainment (IVI), a meter, a head-up display (HUD), and an electronic mirror. FIG. 1 illustrates a first screen 31a, a second screen 31b, and a third screen 31c as multiple screens. The number of screens is not limited and may be two or four or more.

In one example, the device under test 3 is an information processing device that can be provided in a vehicle (in-vehicle device). In one example, the device under test 3 may be an electronic control unit (ECU) or an on-board unit (OBU) provided inside a vehicle. In one example, the device under test 3 may be a domain control unit (DCU) such as a cockpit domain controller (CDC) in which a plurality of ECUs is consolidated. The CDC is configured to execute processing such as IVI and meter control, head-up display (HUD), electronic mirror, and other display device control, and advanced driver-assistance systems (ADAS). In one example, the device under test 3 may be an information presentation device that can be provided in a vehicle, such as an external computer installed near the dashboard of a vehicle or a car navigation device.

The device under test 3 may be configured integrally with a human machine interface (HMI), or may be configured to be linked with an external HMI through communication.

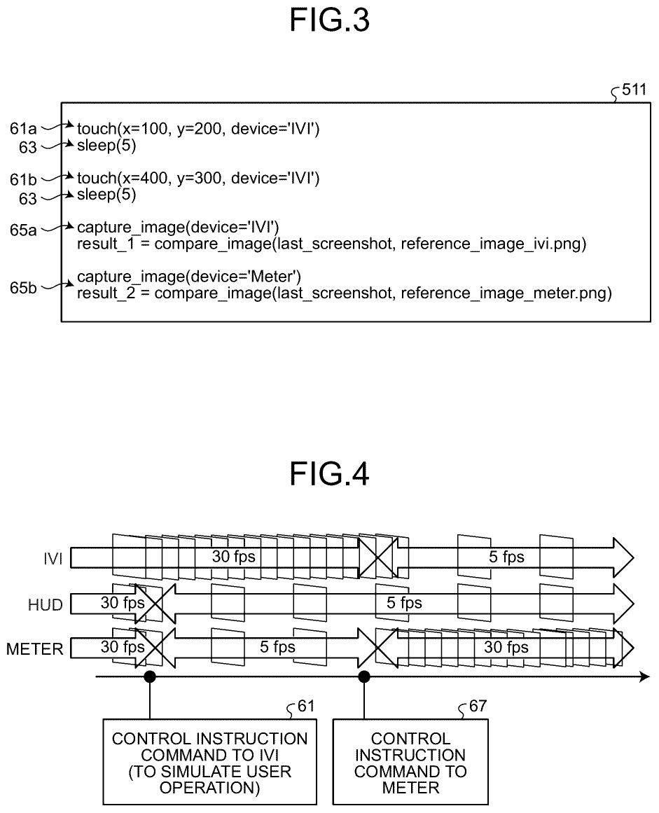

The automatic evaluation device 5 according to one or more embodiments is an example of an evaluation device that executes functional testing to automatically evaluate screen displays in the device to be tested. In one example, the automatic evaluation device 5 executes a test program 511 (see FIG. 3) to evaluate the displays and transitions of the screens of the device under test 3 responding to user operations.

The automatic evaluation device 5 is an information processing device such as, for example, a personal computer (PC). Part of elements of the automatic evaluation device 5 may be implemented by at least one server device on a network such as the Internet or a local area network (LAN), or by the device under test 3. Alternatively, the automatic evaluation device 5 may be at least one server device constructed on a network. Alternatively, the automatic evaluation device 5 may be a device built in the device under test 3.

FIG. 2 is a diagram illustrating an exemplary hardware configuration of each device (3, 5) in the evaluation system 1 according to one or more embodiments. The device under test 3 and the automatic evaluation device 5 each include a processor 91, a main storage device 92, an auxiliary storage device 93, a communication interface 94, an input interface 95, and a display 96. The processor 91, the main storage device 92, the auxiliary storage device 93, the communication interface 94, the input interface 95, and the display 96 are connected by, for example, an internal bus 99 so as to communicate with one another.

The automatic evaluation device 5 does not necessarily have the input interface 95 and the display 96.

The processor 91 (an example of the hardware processor) controls the overall operation performed in the corresponding device 3 or 5. As the processor 91, various processors such as a central processing unit (CPU), a graphics processing unit (GPU), an application specific integrated circuit (ASIC), and a field programmable gate array (FPGA) can be used as appropriate.

The main storage device 92 temporarily stores working data in the corresponding device 3 or 5. In one example, a random access memory (RAM) is used as the main storage device 92.

The auxiliary storage device 93 stores various data and computer programs for use in the corresponding device 3 or 5. As the auxiliary storage device 93, various storage media and storage devices such as a read only memory (ROM), a hard disk drive (HDD), a solid state drive (SSD), and a flash memory can be used as appropriate.

The communication interface 94 is a circuit for communicating with the outside in the corresponding device 3 or 5. The communication interface 94 is a circuit for communication between the device under test 3 and the automatic evaluation device 5. As the communication interface 94, a communication circuit for wired communication, a communication circuit for wireless communication, and a combination thereof can be used as appropriate. As the communication circuit for wireless communication, communication circuits compatible with various standards such as 3G, 4G, 5G, Wi-Fi (registered trademark), and Bluetooth (registered trademark) can be used as appropriate.

The input interface 95 is an example of the HMI installed in the corresponding device 3 or 5. The input interface 95 captures a user's input action in the corresponding device 3 or 5. As the input interface 95, input devices such as a keyboard and a touch panel can be used as appropriate.

The display 96 is an example of the HMI provided in the corresponding device 3 or 5. The display 96 presents a display screen to the user. As the display 96, liquid crystal display (LCD), organic electroluminescence (EL) display, a projector, and the like can be used as appropriate. The display 96 may be configured as a touch panel display. In this case, the touch panel of the display 96 is provided, for example, on a surface of the display 96 and outputs information according to the touched position. The touch panel of the display 96 is an example of the input interface 95 that captures the input of a user operation.

Referring again to FIG. 1, an example of the functional configuration of each device (3, 5) in the evaluation system 1 according to one or more embodiments will now be described.

In the device under test 3, the processor 91 executes a computer program read from the auxiliary storage device 93 and loaded into the main storage device 92 to implement the functions as a screen display unit 32, a control unit 33, and a command receiving unit 34.

The screen display unit 32 controls screen displays on multiple screens (the first screen 31a, the second screen 31b, and the third screen 31c) of the device under test 3 under the control of the control unit 33.

The control unit 33 controls an action of each element of the device under test 3. In one example, the control unit 33 receives various user operations on the device under test 3, such as touch operation and button operation, through the input interface 95. In one example, the control unit 33 controls an action of each element of the device under test 3, based on the received various user operations or commands from the automatic evaluation device 5 received by the command receiving unit 34. The commands each include information indicating a control target and information indicating the content of control (see FIG. 3).

In response to a command (first command) that simulates a user operation from the automatic evaluation device 5, the control unit 33 performs, in an simulative manner, an action responding to the user operation, such as control of screen displays on multiple screens by the screen display unit 32. The action responding to the user operation in a simulative manner refers to controlling of action of each element of the device under test 3 in response to the first command, in the same way as when a user operation on the device under test 3 is detected via the input interface 95. In other words, the action responding to the user operation in a simulative manner is to control an action of each element of the device under test 3 on the assumption that a user operation simulated by a first command is received via the input interface 95 of the device under test 3.

Examples of user operations to be simulated may include operations related to music and video playback on the IVI and operations on the car navigation system. The action of the device under test 3 responding to such a user operation is not limited to screen displays on the IVI, but may be screen displays such as displays of audio information or map information on the meter.

The command receiving unit 34 receives a command from the automatic evaluation device 5 via the communication interface 94.

In the automatic evaluation device 5, the processor 91 executes a computer program read from the auxiliary storage device 93 and loaded into the main storage device 92 to implement the functions as a storage unit 51, a test target screen determination unit 52, a test execution unit 53, and a video capture unit 54.

The storage unit 51 is implemented, for example, by at least one of the main storage device 92 and the auxiliary storage device 93. The storage unit 51 stores a test program 511, reference data 512, and video data 513.

The test program 511 is a script that indicates a test scenario (test procedure) for executing consolidated functional testing by simulating user operations on the device under test 3 having multiple screens. FIG. 3 is a diagram illustrating an example of the test program 511 according to one or more embodiments. FIG. 3 illustrates a case where one of the first screen 31a, the second screen 31b, and the third screen 31c is an IVI screen and one of the other screens is a meter screen. As illustrated in FIG. 3, the test program 511 includes multiple commands that indicate the procedure for the functional testing of the device under test 3.

The example in FIG. 3 illustrates a procedure that executes a command 61a (first command) that causes the IVI to execute an action responding to a user touch operation on a position (x=100, y=200) on the screen, and thereafter executes a sleep command 63 (third command) that instructs the IVI to take a waiting time of 5 seconds. The illustrated procedure thereafter executes a command 61b (first command) that causes IVI to execute an action responding to a user touch operation on a position (x=400, y=300) on the screen, and thereafter executes the sleep command 63 that instructs the IVI to take a waiting time of 5 seconds. The illustrated procedure thereafter executes a command 65a (second command) to capture a screen shot (image) showing a screen display from a video showing screen displays of the IVI captured at a set frame rate, and generate a result of comparison between the captured screen display of the IVI and the reference data 512 as “result1”. The illustrated procedure thereafter executes a command 65b (second command) to capture a screen shot (image) showing a screen display from a video showing screen displays of the meter captured at a set frame rate, and generate a result of comparison between the captured screen display of the meter and an image of the reference data 512 as “result2”.

As described above, in the test program 511, one or more commands including a first command are described. The first command simulates a user operation to cause a device with multiple screens to execute an action responding to the user operation. The test program 511 also includes a second command to compare the captured screen display of the device under test 3 with a reference image of the reference data. The test program 511 also includes a description of a waiting time.

The test program 511 may be supplied from the outside of the automatic evaluation device 5 or may be input or edited via the input interface 95.

The reference data 512 is data of reference images showing screen displays captured in advance for each of the multiple screens of the device under test 3. In one example, the reference data 512 includes, as a reference image serving as a criterion for evaluating a screen display, a screen display caused by an action of the device under test 3 in response to a user operation, which is captured when the user operation simulated by the first command described in the test program 511 is actually performed.

The video data 513 is screen displays, namely, pieces of video data that are successively captured at a frame rate set in the functional testing, for each of the multiple screens of the device under test 3.

The test target screen determination unit 52 determines, from among the multiple screens of the device under test 3, a screen that is relevant to a command executed by the test execution unit 53 out of all commands described in the test program 511. In other words, the test target screen determination unit 52 determines, from among the multiple screens of the device under test 3, a relevant screen that is relevant to a command in an execution phase among all the commands described in the test program 511.

In one example, when a waiting time (sleep state) is described in the test program 511, the test target screen determination unit 52 determines, during the waiting time, which of the multiple screens of the device under test 3 is relevant to the next command to be executed. In other words, when a waiting time is described in the test program 511, the test target screen determination unit 52 determines, during the waiting time, a relevant screen relevant to the next command to be executed. In this way, the configuration that allows the interpretation of the next command to progress during the waiting time can reduce the processing delay due to the determination of a target screen.

As used herein the screen relevant to a command (relevant screen) includes at least one of a screen based on the first command and a screen based on the second command. The screen based on the first command includes a control target screen operated by execution of the first command, a screen whose screen displays are affected by execution of the first command, or a screen to check the effect of execution of the first command on screen displays. The screen based on the second command includes a screen that performs a screen display to be compared with the reference data 512 by execution of the second command.

In one example, the test target screen determination unit 52 determines a screen relevant to a command, based on information indicating a device or a screen described in the command. Specifically, for example, the test target screen determination unit 52 determines that the command 61a is relevant to the IVI, based on the description “device=‘IVI’” in the command 61a. The test target screen determination unit 52 determines that the command 65b is relevant to the meter, based on the description “device=‘Meter’” in the command 65b.

The test execution unit 53 executes the functional testing of the device under test 3 by sequentially executing all the commands described in the test program 511. As used herein “the test execution unit 53 executes a command” means performing a process indicated by the command. In one example, the test execution unit 53 executes a first command that simulates a user operation on a device having multiple screens. Specifically, the test execution unit 53 transmits the first command to the device under test 3 to cause the device under test 3 to execute an action responding to the user operation in a simulative manner.

Moreover, the test execution unit 53 evaluates the result of the functional testing of the device under test 3. In one example, the test execution unit 53 executes a second command to compare the captured screen display of the device under test 3 with a reference image of the reference data. The functional testing as referred to herein may include the evaluation of the result of the functional testing.

The video capture unit 54 successively captures screen displays on multiple screens of the device under test 3. The video capture unit 54 can change, independently for each of the multiple screens, the frequency (frame rate) at which screen displays are successively captured. In accordance with a command that controls one of the multiple screens of the device under test 3, the video capture unit 54 performs a frame rate adjusting process of setting a frame rate at which screen displays are captured, based on the result of determination of the target screen by the test target screen determination unit 52, before a process indicated by the command is performed by the test execution unit 53. The frame rate set in the frame rate adjusting process is not the frame rate of a video used for screen displays in each of the multiple screens in the device under test 3 but the frame rate at which the screen displays are captured from a signal line or from the outside.

In this way, the video capture unit 54 captures screen displays on each of the multiple screens of the device under test 3, at a frame rate based on the result of determination of the target screen by the test target screen determination unit 52. The video capture unit 54 then stores a video of the captured screen displays in the storage unit 51 as video data 513.

The video of the captured screen displays may be stored in the storage unit 51 constantly while the screen displays on each of the multiple screens of the device under test 3 are captured at a set frame rate, or may be stored when the second command to perform comparison, such as the command 65a or 65b, is executed.

In one example, the video capture unit 54 captures screen displays on the screen (relevant screen) that is determined by the test target screen determination unit 52 as being relevant to the command executed by the test execution unit 53 among the multiple screens of the device under test 3, at a first frame rate, and captures screen displays on the screens other than the relevant screen, at a second frame rate lower than the first frame rate. In other words, the video capture unit 54 decreases the capture frequency (frame rate) for the screens that are not control targets while successively capturing screen displays (video). Alternatively, the video capture unit 54 increases the frame rate for the relevant screen that is determined by the test target screen determination unit 52 as being relevant and decreases the frame rate for the other screens.

Increasing in the frame rate refers to setting of the frame rate at which screen displays of the screen are captured to a higher frame rate (first frame rate) for the target screen. In other words, increasing in the frame rate includes increasing in the frame rate to the first frame rate when the frame rate set at the point in time is not the first frame rate. Increasing in the frame rate also includes keeping the first frame rate when the frame rate set at the point in time is the first frame rate.

Decreasing in the frame rate refers to setting of the frame rate at which screen displays of the screen are captured to a lower frame rate (second frame rate) for screens other than the target, which is lower than the first frame rate. In other words, decreasing in the frame rate includes decreasing in the frame rate to the second frame rate when the frame rate set at the point in time is not the second frame rate. Decreasing in the frame rate also includes keeping the second frame rate when the frame rate set at the point in time is the second frame rate. In this case, the lower the second frame rate is set, the greater the load involved with screen capture can be reduced.

In one example, the video capture unit 54 may stops capturing screen displays by setting the second frame rate to zero. In other words, the video capture unit 54 may capture screen displays on the screen (relevant screen) that is determined as being relevant to the executed command among the multiple screens of the device under test 3, at the first frame rate, and stop capturing screen displays on the screens other than the relevant screen. This configuration can further reduce the load involved with screen capture.

In one example, the video capture unit 54 may set different values for the first frame rate and/or the second frame rate for each screen.

In one example, the video capture unit 54 may determine whether to set the second frame rate to zero for each screen or for each screen state. Specifically, for example, the video capture unit 54 may set the second frame rate to zero for a screen, such as IVI, whose screen display can be turned on and off via a user operation. The video capture unit 54 may set the second frame rate to zero for a screen whose screen display is turned off. The video capture unit 54 may determine whether to set the second frame rate to zero, based on information indicating target (non-target) screen candidates that is predetermined and stored in the storage unit 51. The information indicating screen candidates may be preset, for example, by the person who plans/executes functional testing, for example, depending on whether it is necessary to evaluate screen displays. Of course, the information indicating screen candidates may be described in the test program 511.

The screen capture according to one or more embodiments will now be described more specifically with reference to the drawings. FIG. 4 is a diagram illustrating control of screen capture according to one or more embodiments. FIG. 4 illustrates a case where the first screen 31a, the second screen 31b, and the third screen 31c are each any one of the IVI, HUD, and meter screens. In the example in FIG. 4, the first frame rate of the screen (relevant screen) determined by the test target screen determination unit 52 as being relevant is 30 fps, and the second frame rate of the other screens is 5 fps. FIG. 4 illustrates the control of screen capture performed in a state in which the IVI, HUD, and meter screens are set to the first frame rate (30 fps).

If the IVI is determined to be the target screen based on a first command 61, which is a control instruction to the IVI, the video capture unit 54 keeps the frame rate at which screen displays of the IVI are captured at 30 fps (first frame rate) and decreases the frame rate at which screen displays of the other screens (HUD and meter) are captured to 5 fps (second frame rate).

Then, if the meter is determined to be the target screen (relevant screen) based on a first command 67, which is a control instruction to the meter, the video capture unit 54 increases the frame rate at which screen displays of the meter are captured to 30 fps (first frame rate) and decreases the frame rate at which screen displays of the IVI (other screen) are captured to 5 fps (second frame rate) while keeping the frame rate at which screen displays of the HUD (other screen) are captured at 5 fps (second frame rate).

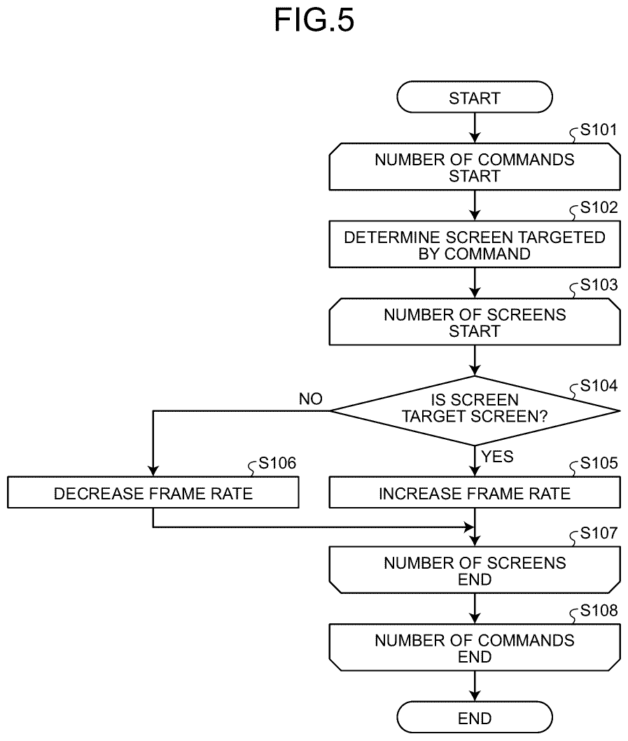

The procedure of an evaluation process executed in the evaluation system 1 configured as described above will now be described. FIG. 5 is a flowchart illustrating an exemplary procedure of the evaluation process executed in the automatic evaluation device 5 according to one or more embodiments.

The automatic evaluation device 5 starts an iterative process (S102 to S107) which is executed as many times as the number of commands described in the test program 511 (S101).

First, based on the description of the test program 511, the automatic evaluation device 5 determines which of the multiple screens is targeted by the command executing, namely, which of the screens is a relevant screen (S102). The automatic evaluation device 5 starts an iterative process (S104 to S106) which is executed as many times as the number of screens of the device under test 3 (S103).

If the screen is a relevant screen targeted by the command executing (Yes at S104), the automatic evaluation device 5 increases the frame rate, which is the frequency at which screen displays of the relevant screen are captured as a continuous image (video) (S105).

If the screen is not the relevant screen targeted by the command executing (No at S104), the automatic evaluation device 5 decreases the frame rate at which screen displays of the screen are captured (S106).

After the processing at S105 or S106, the automatic evaluation device 5 determines whether the iterative process (S104 to S106) has been executed for all the screens of the device under test 3 (S107). In the procedure in FIG. 5, the process returns to S104 if the iterative process has not been executed for all the screens, and after execution, the process proceeds to S108.

After the iterative process has been executed for all the screens, the automatic evaluation device 5 determines whether the iterative process (S102 to S107) has been executed as many times as the number of commands described in the test program 511 (S108). In the procedure in FIG. 5, the process returns to S102 if the iterative process has not been executed for all commands, and after execution, the process ends.

In this way, the automatic evaluation device 5 according to one or more embodiments is configured to read a target screen (relevant screen) to which a command is sent at the beginning of the processing of the command, in the functional testing of the device under test 3, and to set the frame rate at which screen displays of the target relevant screen are captured to the default first frame rate. The automatic evaluation device 5 is configured to set the frame rate at which screen displays of the other screens are captured to a second frame rate lower than the default frame rate.

With this configuration, in the functional testing that screen capture of the device under test 3 having multiple screens is successively performed, it is possible to reduce the load involved with screen capture on the automatic evaluation device 5 while suppressing the effect on the evaluation result by highly keeping the frame rate for the relevant screen which is a control target in the test process.

Moreover, if the load involved with screen capture can be reduced, it is possible to suppress the slow action of the automatic evaluation device 5 due to a load exceeding resources. For example, it is possible to suppress the occurrence of processes such as saving the video data 513 from the main storage device 92 to a destination such as the non-volatile auxiliary storage device 93, thereby suppressing decrease in processing speed. Suppressing decrease in processing speed contributes to the efficiency of the functional testing. Even in a case where the screens under test are recorded, the data volume of the video data 513 can be suppressed, and the storage capacity of the main storage device 92 and the auxiliary storage device 93 can be reduced. In this way, if memory and storage usage can be reduced, even an automatic evaluation device 5 configured with low resources can perform automatic evaluation while capturing videos of multiple screens.

### First Modification

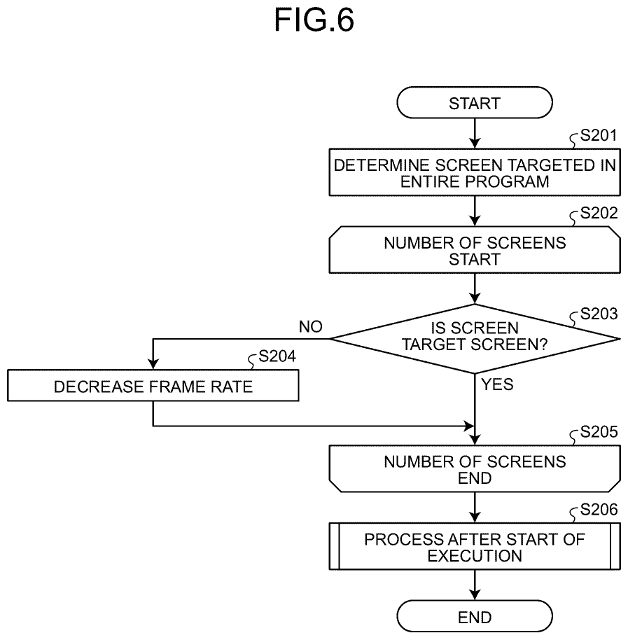

The analysis to determine a target screen based on the description of the test program 511 is not necessarily sequentially performed during execution of the functional testing, but may be performed entirely before the functional testing is executed, for example, immediately before execution. FIG. 6 is a flowchart illustrating another exemplary procedure of the evaluation process executed in the automatic evaluation device 5 according to one or more embodiments.

First, the automatic evaluation device 5 determines relevant screens to be targeted in the entire test program 511 (S201). The automatic evaluation device 5 then starts an iterative process (S203 to S204) which is executed as many times as the number of screens of the device under test 3 (S202).

If the screen is never targeted by a command in the entire test program 511 (No at S203), the automatic evaluation device 5 decreases the frame rate at which screen displays of the screen are captured (S204).

If the screen is a relevant screen targeted by a command at least once in the entire test program 511 (Yes at S203), or after the processing at S204, the automatic evaluation device 5 determines whether the iterative process (S203 to S204) has been executed for all the screens of the device under test 3 (S205). In the procedure in FIG. 6, the process returns to S203 if the iterative process has not been executed for all the screens, and after execution, the process proceeds to S206.

After the process immediately before execution (S201 to S205), the automatic evaluation device 5 executes the process after the start of execution (S206). The process after the start of execution is, for example, the process at S101 to S108 in FIG. 5.

In this way, the automatic evaluation device 5 may determine which of the multiple screens of the device under test 3 is relevant, for all the commands described in the test program 511, in a phase before the functional testing is executed (started), for example, immediately before the functional testing is executed. In other words, the automatic evaluation device 5 may determine a relevant screen relevant to any command among all the commands to be executed in the functional testing, among the multiple screens of the device under test 3, before the functional testing is executed.

This configuration can further reduce the load involved with screen capture because the frame rate can be set to a lower value at the start of the functional testing, for the screen not targeted in the entire functional testing, namely, the screen that is never determined as being relevant to execution of a command.

### Second Modification

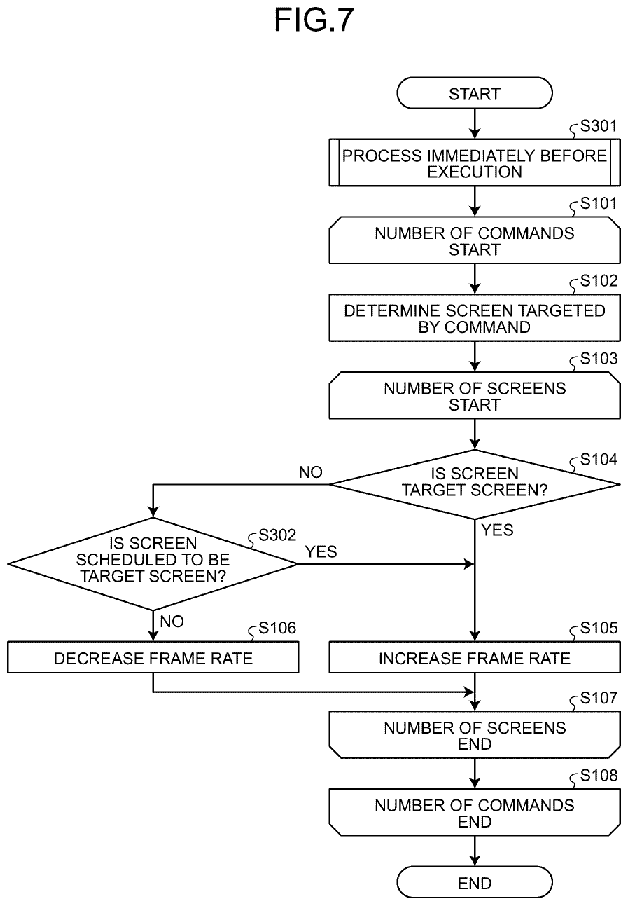

The frame rate adjustment during execution of the functional testing may be performed not only based on whether the screen is a relevant screen relevant to a command executed at the point in time, namely, in the execution phase, but also based on whether the screen is a relevant screen relevant to a command scheduled to be executed later. FIG. 7 is a flowchart illustrating another exemplary procedure of the evaluation process executed in the automatic evaluation device 5 according to one or more embodiments. The differences from the process after the start of execution (S101 to S108) in FIG. 5 will mainly be described.

First, the automatic evaluation device 5 executes the process immediately before execution (S201 to S205) (S301). The process immediately before execution has been described above with reference to FIG. 6 and thus will be omitted.

After the process immediately before execution, the automatic evaluation device 5 executes the process after the start of execution (S101 to S105, S302, and S106 to S108).

If the screen is a relevant screen targeted by the command executing (Yes at S104), the automatic evaluation device 5 increases the frame rate, which is the frequency at which screen displays of the screen are captured as a continuous image (video), in the same way as in the procedure in FIG. 5 (S105).

If the screen is not a relevant screen targeted by the command executing (No at S104), and if the screen is scheduled to be a target relevant screen based on a command scheduled to be executed later (Yes at S302), the automatic evaluation device 5 increases the frame rate at which screen displays of the screen are captured (S105). In other words, even when the screen is not a relevant screen relevant to the command executing at the point in time, the automatic evaluation device 5 does not decrease the frame rate at which screen displays are captured, for a relevant screen relevant to execution of a subsequent command.

In the test program 511 shown in FIG. 3, the meter is not a target screen (relevant screen) relevant to the commands 61a, 61b, and 65a. On the other hand, the meter is a target screen (relevant screen) relevant to the command 65b. In this case, the automatic evaluation device 5 does not decrease the frame rate at which screen displays of the meter are captured. This is because the meter is not a relevant screen at the point in time when the commands 61a, 61b, and 65a are executing but a relevant screen relevant to execution of the subsequent command 65b.

If the screen is not a relevant screen targeted by the command executing (No at S104), and if the screen is not scheduled to be a target relevant screen based on a command scheduled to be executed later (No at S302), the automatic evaluation device 5 decreases the frame rate at which screen displays of the screen are captured (S106), in the same manner as in the procedure in FIG. 5.

In the procedure in FIG. 7, the second frame rate may also be set to zero and the capture of screen displays may be stopped.

Even when the process immediately before execution is not performed, the frame rate adjustment during execution of the functional testing may be performed further based on whether the screen is a relevant screen relevant to a command scheduled to be executed later. In one example, the automatic evaluation device 5 may set (or keep) the first frame rate, even for a screen that turns out to be targeted later to the extent that analysis has progressed during waiting time, in addition to a screen relevant to a command executing.

In this way, during execution of the functional testing, the automatic evaluation device 5 may capture screen displays on the screen determined as being relevant to not only a command in the execution phase but also a command scheduled to be executed later, at the first frame rate, and may capture screen displays on the other screens at the second frame rate.

With this configuration, the frame rate at which screen displays are captured is not decreased for a screen scheduled to be targeted later. Thus, even if there is a delay in determining a target screen or in switching the frame rate, the screen displays on the target screen can be captured at a desired frame rate and appropriate evaluation can be performed.

In each of the embodiments described above, the phrase of “determining whether it is A” may mean “determining that it is A”, “determining that it is not A”, or “determining whether it is A or not”.

The computer program to be executed by each device (3, 5) of the evaluation system 1 in the embodiments above may be provided as a file in an installable or executable format recorded on a computer-readable recording medium such as CD-ROM, FD, CD-R, or DVD.

The computer program to be executed in each device (3, 5) of the evaluation system 1 in the embodiments above may be stored on a computer connected to a network such as the Internet and may be downloaded via the network. The computer program to be executed in each device (3, 5) of the evaluation system 1 in the embodiments above may be provided or distributed via a network such as the Internet.

The computer program to be executed in each device (3, 5) of the evaluation system 1 in the embodiments above may be built in advance in a ROM or the like and provided.

In one example, the computer program executed on the device under test 3 in the foregoing embodiments has a module configuration including the functional units described above (screen display unit 32, control unit 33, and command receiving unit 34), and the processor 91 as actual hardware reads and executes the computer program from the auxiliary storage device 93 so that the functional units described above are loaded onto the main storage device 92 and the functional units described above are generated on the main storage device 92.

In one example, the computer program to be executed by the automatic evaluation device 5 in the embodiments above has a module configuration including the functional units described above (storage unit 51, test target screen determination unit 52, test execution unit 53, and video capture unit 54), and the processor 91 as actual hardware reads and executes the computer program from the auxiliary storage device 93 so that the functional units described above are loaded onto the main storage device 92 and the functional units described above are generated on the main storage device 92.

According to at least one embodiment described above, the load involved with screen capture can be reduced in automatic evaluation for screen displays on a device having multiple screens.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

### Notes

The following technology is disclosed by the foregoing description of the present disclosure.

(1)

An evaluation device comprising:
a storage device configured to store a test program in which one or more commands are described, the one or more commands including a first command simulating a user operation on a device with multiple screens, the first command causing the device to perform an action responding to the user operation; and
a hardware processor connected to the storage device and configured to
   determine, from among the multiple screens, a relevant screen being relevant to a command in an execution phase among all commands described in the test program,
   execute functional testing of the device by sequentially executing all the commands, and
   capture a screen display on each of the multiple screens at a frame rate based on a result of the determination of the relevant screen.
      (2)

The evaluation device according to (1), wherein the hardware processor is configured to, among the multiple screens,
capture a screen display on the relevant screen at a first frame rate, and
capture screen displays on screens other than the relevant screen at a second frame rate lower than the first frame rate.
   (3)

The evaluation device according to (1) or (2), wherein the hardware processor is configured to, among the multiple screens,
capture a screen display on the relevant screen at a first frame rate, and
stop capturing screen displays on screens other than the relevant screen.
   (4)

The evaluation device according to (1), wherein the hardware processor is configured to,
before the functional testing is executed, determine the relevant screen being relevant to a command from among all the commands to be executed in the functional testing of the device, and
set, to a second frame rate, a frame rate at which screen displays on screens other than the relevant screen among the multiple screens are captured, the second frame rate being lower than a first frame rate at which a screen display on the relevant screen is captured.
   (5)

The evaluation device according to (4), wherein the relevant screen is a screen determined as being relevant to at least one of the command in an execution phase and a command scheduled to be executed later during execution of the functional testing.

(6)

The evaluation device according to (4) or (5), wherein
the relevant screen is a screen determined as being relevant to at least one of the command in an execution phase and a command scheduled to be executed later during execution of the functional testing, and
the hardware processor is configured to stop capturing screen displays on the screens other than the relevant screen by setting the second frame rate to zero.
   (7)

The evaluation device according to any one of (1) to (6), wherein, when a waiting time is described in the test program, the hardware processor is configured to determine, during the waiting time, the relevant screen relevant to a command to be executed next to the command in the execution phase among all the commands.

(8)

The evaluation device according to any one of (1) to (7), wherein
the storage device is configured to store a reference image serving as a criterion for evaluating a screen display,
the one or more commands include a second command to compare the captured screen display with the reference image, and
the hardware processor is configured to evaluate a result of the functional testing by executing the second command.
   (9)

The evaluation device according to (8), wherein the hardware processor is configured to determine that, among the multiple screens, a control target screen and/or a comparison target screen are/is the relevant screen, the control target screen being a screen operated by execution of the first command, the comparison target screen being a screen compared by execution of the second command.

(10)

An evaluation method implemented by a computer, the evaluation method comprising:
storing, in a storage device, a test program in which one or more commands are described, the one or more commands including a first command simulating a user operation on a device with multiple screens, the first command causing the device to perform an action responding to the user operation;
determining, from among the multiple screens, a relevant screen being relevant to a command in an execution phase among all commands described in the test program;
executing functional testing of the device by sequentially executing all the commands; and
capturing a screen display on each of the multiple screens at a frame rate based on a result of the determining of the relevant screen.
   (11)

An evaluation method comprising:
determining, from among multiple screens of a device, a relevant screen relevant to a command in an execution phase among one or more commands described in a test program, the one or more commands including a first command simulating a user operation on a device with multiple screens to cause the device to execute an action responding to the user operation;
executing functional testing of the device by sequentially executing all commands described in the test program; and
capturing a screen display on each of the multiple screens at a frame rate based on a result of the determination.
   (12)

A computer program in which programmed instructions are described, the instructions, when executed by a computer, causing the computer to perform:
determining, from among multiple screens of a device, a relevant screen relevant to a command in an execution phase among one or more commands described in a test program, the one or more commands including a first command simulating a user operation on a device with multiple screens to cause the device to execute an action responding to the user operation;
executing functional testing of the device by sequentially executing all commands described in the test program; and
capturing a screen display on each of the multiple screens at a frame rate based on a result of the determination.
   (13)

A computer program product comprising a non-transitory computer readable medium storing the computer program according to (12).

What is claimed is:

1. An evaluation device comprising:
a storage device configured to store a test program in which one or more commands are described, the one or more commands including a first command simulating a user operation on a device with multiple screens, the first command causing the device to perform an action responding to the user operation; and
a hardware processor connected to the storage device and configured to
determine, from among the multiple screens, a relevant screen being relevant to a command in an execution phase among all commands described in the test program,
execute functional testing of the device by sequentially executing all the commands, and
capture a screen display on each of the multiple screens at a frame rate based on a result of the determination of the relevant screen.

2. The evaluation device according to claim 1, wherein the hardware processor is configured to, among the multiple screens,
capture a screen display on the relevant screen at a first frame rate, and
capture screen displays on screens other than the relevant screen at a second frame rate lower than the first frame rate.

3. The evaluation device according to claim 1, wherein the hardware processor is configured to, among the multiple screens,
capture a screen display on the relevant screen at a first frame rate, and
stop capturing screen displays on screens other than the relevant screen.

4. The evaluation device according to claim 1, wherein the hardware processor is configured to,
before the functional testing is executed, determine the relevant screen being relevant to a command from among all the commands to be executed in the functional testing of the device, and
set, to a second frame rate, a frame rate at which screen displays on screens other than the relevant screen among the multiple screens are captured, the second frame rate being lower than a first frame rate at which a screen display on the relevant screen is captured.

5. The evaluation device according to claim 4, wherein the relevant screen is a screen determined as being relevant to at least one of the command in an execution phase and a command scheduled to be executed later during execution of the functional testing.

6. The evaluation device according to claim 4, wherein
the relevant screen is a screen determined as being relevant to at least one of the command in an execution phase and a command scheduled to be executed later during execution of the functional testing, and
the hardware processor is configured to stop capturing screen displays on the screens other than the relevant screen by setting the second frame rate to zero.

7. The evaluation device according to claim 1, wherein, when a waiting time is described in the test program, the hardware processor is configured to determine, during the waiting time, the relevant screen relevant to a command to be executed next to the command in the execution phase among all the commands.

8. The evaluation device according to claim 1, wherein
the storage device is configured to store a reference image serving as a criterion for evaluating a screen display,
the one or more commands include a second command to compare the captured screen display with the reference image, and
the hardware processor is configured to evaluate a result of the functional testing by executing the second command.

9. The evaluation device according to claim 8, wherein the hardware processor is configured to determine that, among the multiple screens, a control target screen and/or a comparison target screen are/is the relevant screen, the control target screen being a screen operated by execution of the first command, the comparison target screen being a screen compared by execution of the second command.

10. An evaluation method implemented by a computer, the evaluation method comprising:
storing, in a storage device, a test program in which one or more commands are described, the one or more commands including a first command simulating a user operation on a device with multiple screens, the first command causing the device to perform an action responding to the user operation;
determining, from among the multiple screens, a relevant screen being relevant to a command in an execution phase among all commands described in the test program;
executing functional testing of the device by sequentially executing all the commands; and
capturing a screen display on each of the multiple screens at a frame rate based on a result of the determining of the relevant screen.

11. The evaluation method according to claim 10, wherein the capturing includes, among the multiple screens,
capturing a screen display on the relevant screen at a first frame rate, and
capturing screen displays on screens other than the relevant screen at a second frame rate lower than the first frame rate.

12. The evaluation method according to claim 10, wherein the capturing includes, among the multiple screens,
capturing a screen display on the relevant screen at a first frame rate, and
stopping capturing screen displays on screens other than the relevant screen.

13. The evaluation method according to claim 10, wherein
the determining includes, before the functional testing is executed, determining the relevant screen being relevant to a command from among all the commands to be executed in the functional testing of the device, and
the capturing includes, setting, to a second frame rate, a frame rate at which screen displays on screens other than the relevant screen among the multiple screens are captured, the second frame rate being lower than a first frame rate at which a screen display on the relevant screen is captured.

14. The evaluation method according to claim 13, wherein the relevant screen is a screen determined as being relevant to at least one of the command in an execution phase and a command scheduled to be executed later during execution of the functional testing.

15. The evaluation method according to claim 13, wherein
the relevant screen is a screen determined as being relevant to at least one of the command in an execution phase and a command scheduled to be executed later during execution of the functional testing, and
the capturing includes stopping capturing screen displays on the screens other than the relevant screen by setting the second frame rate to zero.

16. The evaluation method according to claim 10, wherein, when a waiting time is described in the test program, the determining includes determining, during the waiting time, the relevant screen relevant to a command to be executed next to the command in the execution phase among all the commands.

17. The evaluation method according to claim 10, further comprising storing, in the storage device, a reference image serving as a criterion for evaluating a screen display, wherein
the one or more commands include a second command to compare the captured screen display with the reference image, and
the executing includes evaluating a result of the functional testing by executing the second command.

18. The evaluation method according to claim 17, wherein the determining includes determining that, among the multiple screens, a control target screen and/or a comparison target screen are/is the relevant screen, the control target screen being a screen operated by execution of the first command, the comparison target screen being a screen compared by execution of the second command.
